(19) United States
(12) Patent Application Publication
(10) Pub. No.: US 2016/0375770 A1
(43) Pub. Date: Dec. 29, 2016

(54) STEERING ASSEMBLY AND METHOD OF CONTROL

(71) Applicant: STEERING SOLUTIONS IP HOLDING CORPORATION, Saginaw, MI (US)

(72) Inventors: Patrik M. Ryne, Midland, MI (US); Richard K. Riefe, Saginaw, MI (US); Frank P. Lubischer, Commerce Twp., MI (US); Timothy W. Kaufmann, Frankenmuth, MI (US)

(21) Appl. No.: 15/191,589

(22) Filed: Jun. 24, 2016

Related U.S. Application Data
(60) Provisional application No. 62/184,627, filed on Jun. 25, 2015.

(51) Int. Cl. B60K 35/00; B62D 1/10; G05D 1/00

(52) U.S. Cl. CPC B60K 35/00; G05D 1/0088; B62D 1/10; B60K 2350/928

(57) ABSTRACT

A steering assembly that is provided with an autonomous vehicle includes a display interface and a controller. The display interface is disposed on a steering wheel and is configured to display an image. The controller is in communication with the display interface and an advanced driver assist system. The controller is configured to operate the display interface to display the image in response to activation of the advanced driver assist system and orient the image based on a rotational position of the steering wheel.

### CROSS-REFERENCES TO RELATED APPLICATIONS

This patent application claims priority to U.S. Provisional Patent Application Ser. No. 62/184,627, filed Jun. 25, 2015 which is incorporated herein by reference in its entirety.

### BACKGROUND OF THE INVENTION

Vehicle steering wheels are typically used to provide directional control of a vehicle. Autonomous vehicles are provided with advanced sensors, electronics, and controllers to provide directional control of the vehicle without driver intervention. An operator of the autonomous vehicle may be able to perform non-driving activities while the autonomous vehicle is controlled by the advanced sensors, electronics, or controllers.

### SUMMARY OF THE INVENTION

According to an embodiment of the present disclosure, a steering assembly is provided. The steering assembly includes a steering wheel, an advanced driver assist system, a display interface, and a controller. The steering wheel is selectively coupled to a steering shaft and has a hub. The advanced driver assist system is in communication with the steering wheel and is configured to selectively control an autonomous vehicle. The display interface is disposed within the hub of the steering wheel and is configured to display an image. The controller is in communication with the advanced driver assist system and the display interface. The controller is configured to orient the image with respect to a desired axis based on a rotational position of the steering wheel.

According to another embodiment of the present disclosure, a steering assembly that is provided with an autonomous vehicle is provided. The steering assembly includes a display interface and a controller. The display interface is disposed on a steering wheel and is configured to display an image. The controller is in communication with the display interface and an advanced driver assist system.

The controller is configured to operate the display interface to display the image in response to activation of the advanced driver assist system and orient the image based on a rotational position of the steering wheel.

According to yet another embodiment of the present disclosure, a method is provided. The method includes displaying an image via a display interface that is disposed on a steering wheel. The method further includes rotating the image in a second direction that is disposed opposite the first direction based on an angle of the steering wheel, in response to rotation of the steering wheel.

These and other advantages and features will become more apparent from the following description taken in conjunction with the drawings.

### BRIEF DESCRIPTION OF THE DRAWINGS

The subject matter which is regarded as the invention is particularly pointed out and distinctly claimed in the claims at the conclusion of the specification. The foregoing and other features, and advantages of the invention are apparent from the following detailed description taken in conjunction with the accompanying drawings in which:

FIG. 1 a side view of a vehicle compartment having a steering assembly;

FIG. 2 is perspective view of a steering wheel of the steering assembly having a display interface in a non-rotated position in a first display mode;

FIG. 3 is a perspective view of the steering wheel having the display interface in a rotated position in the first display mode;

FIG. 4 is a perspective view of the steering wheel having the display interface in a non-rotated position in a second display mode;

FIG. 5 is a perspective view of the steering wheel having the display interface in a rotated position in the second display mode; and

FIG. 6 is a flowchart illustrating a method of displaying an image on a display interface of a steering wheel provided with a steering assembly.

### DETAILED DESCRIPTION

Referring now to the Figures, where the present disclosure will be described with reference to specific embodiments, without limiting same, it is to be understood that the disclosed embodiments are merely illustrative of the present disclosure that may be embodied in various and alternative forms. The figures are not necessarily to scale; some features may be exaggerated or minimized to show details of particular components. Therefore, specific structural and functional details disclosed herein are not to be interpreted as limiting, but merely as a representative basis for teaching one skilled in the art to variously employ the present disclosure.

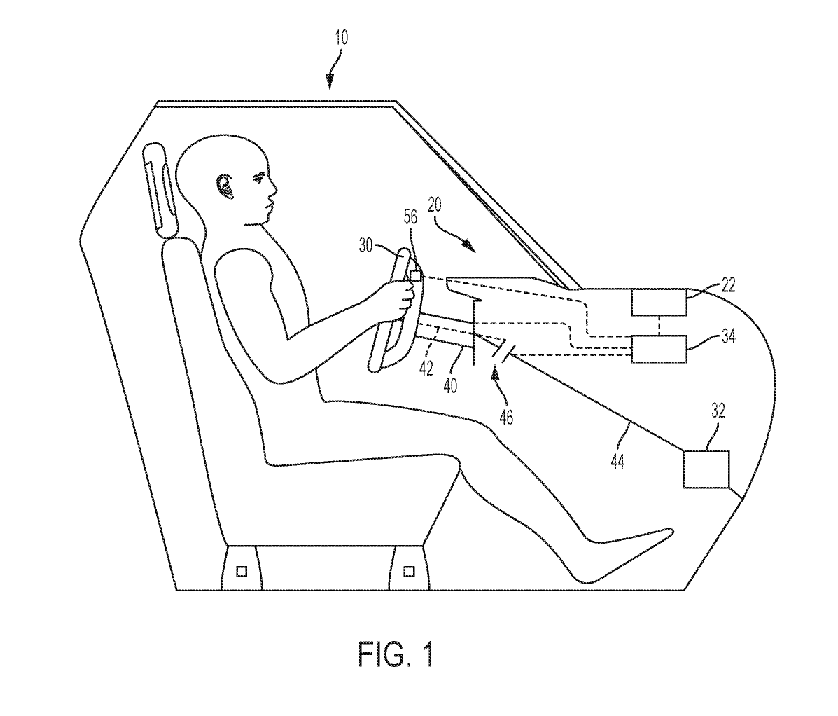

Referring to FIG. 1 a side view of a vehicle compartment 10 within an autonomous vehicle, an autonomously driven vehicle, or a selectively autonomous vehicle, is shown. The autonomous vehicle, the autonomously driven vehicle, or the selectively autonomous vehicle is provided with a steering assembly 20 and an autonomous driving assisted steering system or advanced driver assist system (ADAS) 22.

The ADAS 22 is configured to selectively control the autonomous vehicle, the autonomously driven vehicle, or the selectively autonomous vehicle using sensing, steering, and/or braking technology without continuous input from a driver (e.g. steering, accelerating, braking, maneuvering, etc.). A driver of the vehicle is able to selectively activate or deactivate the ADAS 22 via a switch or other mechanism. A vehicle monitoring system is able to selectively activate or deactivate the ADAS 22 in response to events occurring internally or externally to the vehicle.

The steering assembly 20 includes a steering wheel 30, a steering gear 32, and a controller 34. The steering wheel 30 is operatively connected to a steering column 40. The combination of the steering wheel 30 and the steering column 40 may be extendable or retractable along a longitudinal axis 42 that extends through the steering column 40.

The steering wheel 30 is directly or indirectly selectively coupled to a steering shaft 44 that is connected to the steering gear 32 or is directly or indirectly selectively coupled to the steering gear 32. The steering wheel 30 is directly or indirectly selectively coupled to the steering shaft 44 by a coupling mechanism 46. The coupling mechanism 46 may include a disconnect clutch or the like.

The steering wheel 30 is coupled to the steering shaft 44 when the disconnect clutch of the coupling mechanism 46 is at least partially engaged and the ADAS 22 is deactivated. The steering wheel 30 is decoupled from the steering shaft 44 when the disconnect clutch of the coupling mechanism 46 is disengaged and the ADAS 22 is activated. It is to be appreciated that “decoupling” the steering wheel 30 from the steering shaft 44 may be done mechanically, electrically, or a combination thereof.

The rotation of the steering shaft 44 rotates or actuates the steering gear 32 to pivot at least one vehicle wheel to steer or turn the vehicle. The steering shaft 44 may be rotated by the ADAS 22 or by driver input provided to the steering wheel 30.

In at least one embodiment, the coupling mechanism 46 is configured as a component of a steer by wire system that electrically couples the steering wheel 30 to the steering shaft 44 connected to the steering gear 32. The coupling mechanism 46 includes a device, such as a rotary encoder, that interprets rotation of the steering wheel 30 and applies the information to an actuator that rotates the steering shaft 44 connected to the steering gear 32 that pivots at least one vehicle wheel.

The steering wheel 30 is switchable between a rotatable condition and a non-rotatable condition. The steering wheel 30 is in a rotatable condition when the ADAS 22 is deactivated. The driver of the vehicle provides directional control of the vehicle through the steering wheel 30 when the ADAS 22 is deactivated.

The ADAS 22 provides directional control of the vehicle when the ADAS 22 is activated. The steering wheel 30 may be in a non-rotatable condition or inhibited from rotating when the ADAS 22 is activated. In at least one embodiment, the steering wheel 30 may be rotatable but not provide directional control of the vehicle while the ADAS is activated. In at least one embodiment, the steering shaft 44 counter rotates such that no rotation of the steering wheel 30 is caused by the performance of steering maneuvers controlled by the ADAS 22 when the ADAS 22 is activated. In at least one embodiment, the steering wheel 30 may be permitted or enabled to be rotated by at least one of the driver of the vehicle or the steering shaft 44 while not providing input to the steering gear 32 when the ADAS 22 is activated.

The steering wheel 30 includes a hub 50, a rim 52, a display interface 54, and a sensor system 56. The rim 52 extends at least partially about the hub 50. The display interface 54 is mounted to the steering wheel 30 and is disposed within the hub at 50 of the steering wheel 30.

The display interface 54 may be a touch sensitive screen or a non-touch sensitive screen. The display interface 54 is configured to display at least one image 60. The at least one image 60 may provide information relative to a vehicle operational condition or a vehicle environmental condition, such as vehicle speed, engine/propulsion system speed, fuel level, battery charge level, cabin temperature, engine/propulsion system temperature, vehicle camera views, sensor status, vehicle navigation, traffic warnings, audio controls, nomadic device display, or vehicle warning/condition lights.

The sensor system 56 is disposed on or disposed within the steering column 40 or the hub 50 of the steering wheel 30. The sensor system 56 includes at least one of a steering wheel angular/rotational position sensor 70, an accelerometer 72, and a level sensor 74.

The steering wheel angular/rotational position sensor 70 is configured to provide a signal indicative of a rotational position of the steering wheel 30, an angular position of the steering wheel 30, or a rate at which the steering wheel 30 is being turned or rotated to the controller 34. The steering wheel angular/rotational position sensor 70 may include an optical sensor provided with photodiodes that are configured to read or monitor indicators disposed on a portion of the steering column 40.

The accelerometer 72 is configured to provide a signal indicative of an angular or rotational position of the steering wheel 30 relative to the direction of Earth's gravity to the controller 34. For example, the accelerometer 72 may be a two or three axis accelerometer that is configured to monitor changes in gravitational pull. In at least one embodiment, the accelerometer 72 may be replaced by a gyroscope. The gyroscope is configured to provide a signal indicative of the orientation or angular position of the steering wheel 30 using Earth's gravity to the controller 34.

The level sensor 74 is configured to provide a signal indicative of an angle or position of the steering wheel 30 relative to a desired axis 80 to the controller 34. The desired axis 80 may be a horizontal axis that is disposed substantially transverse to the longitudinal axis 42 and indicates a level or upright position of the at least one image 60 displayed by the display interface 54. In at least one embodiment, the desired axis 80 may be determined or set by the driver of the vehicle. The driver of the vehicle may set the desired axis 80 such that the desired axis 80 may be a vertical axis, an axis disposed at an angle between a horizontal axis and a vertical axis, or the like.

The controller 34 is in communication with the ADAS 22, the steering wheel 30, the display interface 54, and the sensor system 56. The controller 34 is provided as part of the ADAS 22 or a separate component. The controller 34 is configured to receive information or signals from the ADAS 22, a sensor associated with the ADAS 22, the steering wheel 30, the steering shaft 44, the coupling mechanism 46, the display interface 54, and the sensor system 56.

The controller 34 includes a microprocessor or central processing unit (CPU) in communication with various types of computer readable storage devices or media. Computer readable storage devices or media may include volatile and nonvolatile storage in read-only memory (ROM), random-access memory (RAM), and keep-alive memory (KAM), for example. KAM is a persistent or non-volatile memory that may be used to store various operating variables while the CPU is powered down. Computer-readable storage devices or media may be implemented using any of a number of known memory devices such as PROMs (programmable read-only memory), EPROMs (electrically PROM), EEPROMs (electrically erasable PROM), flash memory, or any other electric, magnetic, optical, or combination memory devices capable of storing data, some of which represent executable instructions, used by the controller 34 in controlling the steering assembly 20 and the ADAS 22.

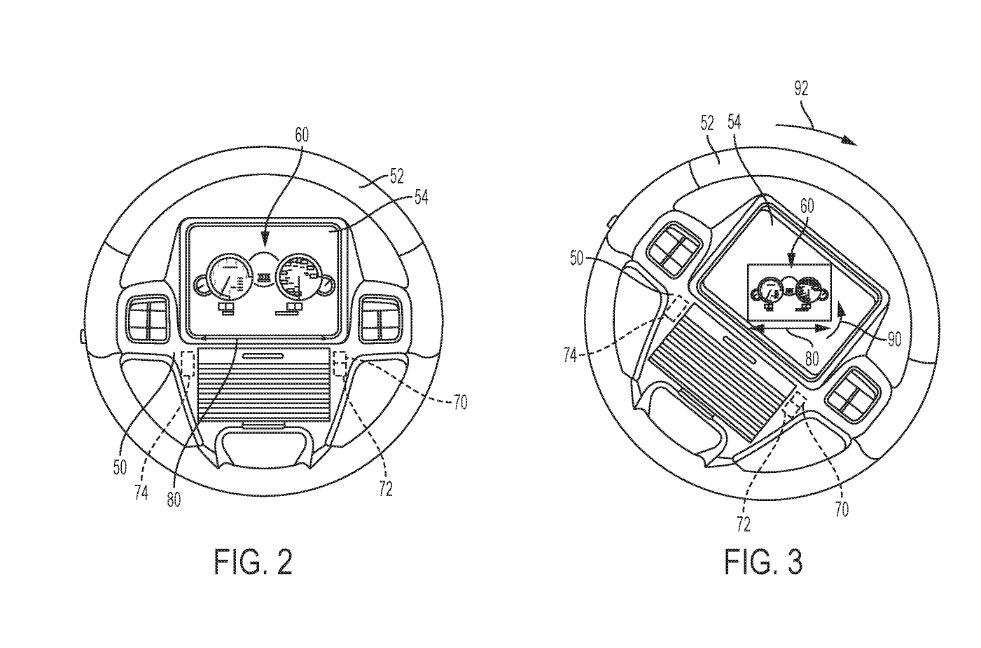

Referring to FIGS. 2-5, the controller 34 interprets the various signals provided by the steering wheel 30, the display interface 54, and the sensor system 56 to orient the at least one image 60 relative to the desired axis 80. The controller 34 is further configured to automatically change the scale or size of the at least one image 60.

The controller 34 is configured to rotate the at least one image 60 in a direction opposite the direction of rotation of the steering wheel 30. For example, should the steering wheel 30 be rotated in a first direction, the controller 34 is configured to orient or rotate the at least one image 60 in a second direction that is disposed opposite the first direction. The amount or degree of rotation in the second direction is based on the angular or rotational position of the steering wheel 30 relative to the desired axis 80 and a refresh rate of the display interface 54. The refresh rate of the display interface 54 may be within a range of 60 Hz to 120 Hz. A rotational leveling of the at least one image 60 is nearly continuous and seamless with any degree of rotation of the steering wheel 30 to keep the at least one image 60 horizontal relative to the desired axis 80.

Referring to FIGS. 2 and 3, the controller 34 is configured to operate the display interface 54 in a first display mode. The display interface 54 is configured to display the at least one image 60 as a non-segmented image within the display interface 54 while operating in the first display mode. The non-segmented image is counter rotated, as a whole, in a counter direction 90 to a rotation direction 92 of the steering wheel 30.

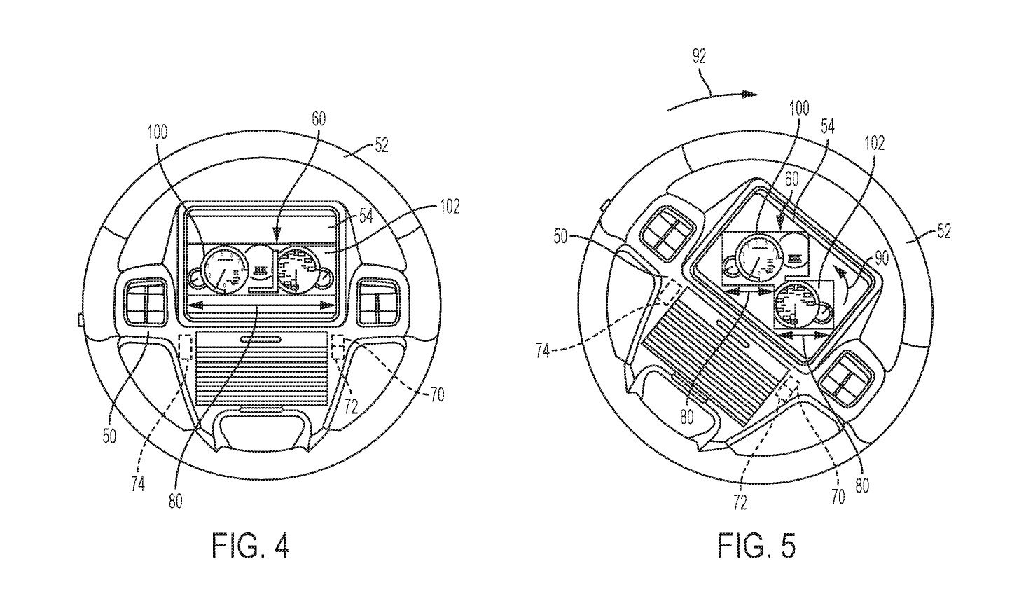

Referring to FIGS. 4 and 5, the controller 34 is configured to operate the display interface 54 in a second display mode. The display interface 54 is configured to display the at least one image 60 as a segmented image within the display interface while operating in the second display mode. The segmented image includes a first image portion 100 and a second image portion 102.

The first image portion 100 and the second image portion 102 are individually oriented with respect to the desired axis 80 based on the angular or rotational position of the steering wheel 30. In at least one embodiment, a relative location of the first image portion 100 and the second image portion 102 are moved relative to one another as the steering wheel 30 is rotated. The relocation of the first image portion 100 and the second image portion 102 may enable at least one of the first image portion 100 and the second image portion 102 to be sized, scaled, or rotated with respect to the desired axis 80 based on the angular or rotational position of the steering wheel 30.

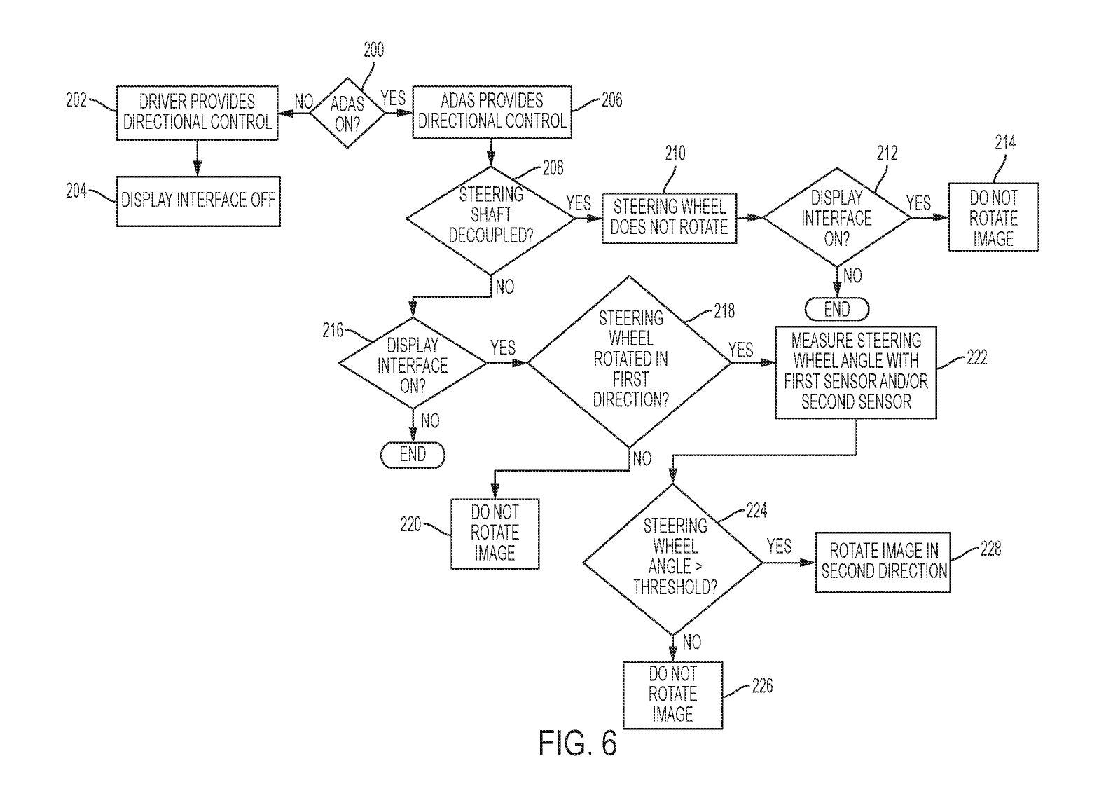

Referring to FIG. 6, a flowchart of an illustrative method of orienting at least one image 60 within the display interface 54 is shown. The method may be implemented or executed by control logic that may be implemented or affected in hardware, software, or a combination of hardware by at least one microprocessor of the controller 34. For brevity, the method will be described in the context of a single method iteration below.

At block 200, the method assesses whether the ADAS 22 is activated and operational. Should the ADAS 22 not be on and operational, the method continues to block 202. At block 202, the driver of the vehicle provides directional control of the vehicle through the steering wheel 30. At block 204, the display interface 54 may be inhibited from displaying at least one image 64 or the display interface 54 may be off.

Returning to block 200, if the ADAS 22 is activated and operational, the method continues to block 206. At block 206, the ADAS 22 provides directional control of the vehicle. As the ADAS 22 provides directional control of the vehicle, the steering wheel 30 may not be used by the driver of the vehicle to provide directional control of the vehicle and the method continues to block 208.

At block 208, the method assesses whether the steering wheel 30 is operatively decoupled from the steering gear 32 or the steering shaft 44 is operatively decoupled from the steering wheel 30. Should the steering shaft 44 be operatively decoupled from the steering wheel 30 the method continues to block 210. At block 210 the steering wheel 30 does not rotate or is in a non-rotatable condition and the method continues to block 212.

At block 212 the method assesses whether the display interface 54 is on and operational. Should the display interface 54 not be on, the method may end. If the display interface is on and operational and displaying at least one image 60 the method continues to block 214. At block 214, the method may not rotate or may be inhibited from rotating the at least one image 60.

Returning to block 208, if the steering shaft 44 is not operatively decoupled from the steering wheel 30 or the steering wheel 30 is not operatively decoupled from the steering gear 32 or the steering shaft 44, the method continues to block 216. At block 216, the method assesses whether the display interface 54 is on and operational. Should the display interface 54 not to be on and operational, the method may end. If the display interface 54 is on and operational and displaying at least one image 60, the method continues to block 218.

At block 218, the method determines or assesses whether the steering wheel 30 is rotated in a first direction. Should the steering wheel 30 not be rotated in a first direction or in any direction, the method continues to block 220. At block 220, the at least one image is not rotated in a second direction or in any direction. If the steering wheel 30 is rotated in a first direction, the method continues to block 222.

At block 222, the method measures or determines an angular or rotational position of the steering wheel 30 in the first direction using at least one sensor of the sensor system 56. In at least one embodiment, measuring or determining the angular rotational position of steering wheel 30 in the first direction includes comparing at least one of a first steering wheel angle provided by the steering wheel angular/rotational position sensor 70 and a second steering wheel angle provided by the accelerometer 72 to each other or to a steering wheel angle threshold.

At block 224, the method compares the measured angular or rotational position of the steering wheel 30 to a threshold steering wheel angle. Should the measured angular or rotational position of steering wheel 30 be less than or within the threshold steering wheel angle, the method continues to block 226. At block 226 the method may not rotate the at least one image 60 or may inhibit rotation of the at least one image 60.

Returning to block 224, if the measured angular or rotational position of the steering wheel 30 is greater than or exceeds the threshold steering wheel angle, the method continues to block 228. At block 228, the method may rotate the at least one image 60 in a second direction opposite the first direction of rotation of the steering wheel 30.

While the invention has been described in detail in connection with only a limited number of embodiments, it should be readily understood that the invention is not limited to such disclosed embodiments. Rather, the invention can be modified to incorporate any number of variations, alterations, substitutions or equivalent arrangements not heretofore described, but which are commensurate with the scope of the invention. Additionally, while various embodiments of the invention have been described, it is to be understood that aspects of the invention may include only some of the described embodiments. Accordingly, the invention is not to be seen as limited by the foregoing description.

Having thus described the invention, it is claimed:

1. A steering assembly, comprising:
a steering wheel selectively coupled to a steering shaft, the steering wheel having a hub;
an advanced driver assist system in communication with the steering wheel, the advanced driver assist system being configured to selectively control an autonomous vehicle;
a display interface disposed within the hub of the steering wheel, the display interface being configured to display an image; and
a controller in communication with the advanced driver assist system and the display interface, the controller being configured to orient the image with respect to a desired axis based on a rotational position of the steering wheel.

2. The steering assembly of claim 1, wherein the controller is further configured to orient the image with respect to the desired axis, the desired axis being a horizontal axis, based on a refresh rate of the display interface.

3. The steering assembly of claim 1, further comprising a position sensor disposed within the steering wheel, configured to provide a signal indicative of the rotational position of the steering wheel to the controller.

4. The steering assembly of claim 1, further comprising an accelerometer disposed within the steering wheel, configured to provide a signal indicative of the rotational position of the steering wheel to the controller.

5. The steering assembly of claim 1, wherein the controller is configured to operate the display interface in a first display mode and a second display mode.

6. The steering assembly of claim 5, wherein while the display interface is operated in the first display mode, the image is displayed as a non-segmented image within the display interface.

7. The steering assembly of claim 6, wherein while the display interface is operated in the second display mode, the image is displayed as a segmented image having a first image portion and a second image portion.

8. The steering assembly of claim 7, wherein the first image portion and the second image portion are individually oriented with respect to the desired axis, the desired axis being a horizontal axis, based on the rotational position of the steering wheel.

9. The steering assembly of claim 7, wherein a relative location of the first image portion and the second image portion are moved relative to each other, with respect to the desired axis based on the rotational position of the steering wheel.

10. A steering assembly provided with an autonomous vehicle, the steering assembly, comprising:
a display interface disposed on a steering wheel, the display interface being configured to display an image; and
a controller in communication with the display interface and an advanced driver assist system, the controller being configured to operate the display interface to display the image in response to activation of the advanced driver assist system and orient the image based on a rotational position of the steering wheel.

11. The steering assembly of claim 10, further comprising a position sensor disposed within the steering wheel and the position sensor is configured to provide a signal indicative of the rotational position of the steering wheel to the controller.

12. The steering assembly of claim 11, wherein the controller is configured to orient the image relative to a horizontal axis.

13. The steering assembly of claim 12, wherein in response to rotation of the steering wheel in a first direction, the controller is configured to operate the display interface to rotate the image in a second direction disposed opposite the first direction.

14. A method comprising:
displaying an image via a display interface disposed on a steering wheel; and
in response to rotation of the steering wheel in a first direction, rotating the image in a second direction disposed opposite the first direction based on an angle of the steering wheel.

15. The method of claim 14, wherein rotation of the image in the second direction is further based on a refresh rate of the display interface.

16. The method of claim 14, further comprising comparing at least one of a first steering wheel angle provided by a position sensor and a second steering wheel angle provided by an accelerometer to a steering wheel angle threshold.

17. The method of claim 16, wherein in response to at least one of the first steering wheel angle and the second steering wheel angle being less than the steering wheel angle threshold, inhibiting rotation of the image in the second direction.

18. The method of claim 17, wherein in response to at least one of the first steering wheel angle and the second steering wheel angle being greater than the steering wheel angle threshold, rotating the image in the second direction.
